(19) United States
(12) Patent Application Publication
(10) Pub. No.: US 2022/0326062 A1
(43) Pub. Date: Oct. 13, 2022

(54) Sensor Indicator

(71) Applicants: Ramin Najafi, Novato, CA (US); Kelly Farideh Farhangi, Novato, CA (US)

(72) Inventors: Ramin Najafi, Novato, CA (US); Kelly Farideh Farhangi, Novato, CA (US)

(21) Appl. No.: 17/709,026

(22) Filed: Mar. 30, 2022

Related U.S. Application Data
(60) Provisional application No. 63/168,193, filed on Mar. 30, 2021.

(51) Int. Cl. G01F 23/00; G01F 23/80; G08B 5/36

(52) U.S. Cl. CPC G01F 23/0015; G01F 23/802; G08B 5/36

(57) ABSTRACT

In one implementation, the specification discloses a liquid level sensor and communication device, system and/or method. In some implementations, the communication light weight portable, interactive device for personal or interpersonal non-video communication using voice messaging comprising a substantially thin polylateral shaped housing unit comprising: a) a front cover, a back cover and side walls connecting the front cover with the back cover; b) a digital sound recording unit configured with a manual switch for activating and recording a message; c) a digital sound storage unit; d) a playback unit configured with a manual switch for activating and playing back the recorded message; e) a microphone; and f) a speaker; and optionally,
i) a light emitting device (LED) indicator or an audio indicator or a combination thereof, for indicating or alerting the presence of a recorded message; and/or
ii) a manual ON/OFF switch for turning on and turning off the device when the device is not in use; wherein the sound recording unit, sound storage unit, playback unit, microphone and speaker are configured to allow a user to record a message and playback the message using the manual switches; and methods for using the device and/or
iii) on/off switch also have a learning mechanism, by placing the unit on the empty part of the container and pressing on/off a number of times. Then the unit will learn the specifics of the bottle and will react to the filled portion of the bottle.

### BACKGROUND

In some implementations, the present developments relate to a talking electronic liquid level indicator, or also/otherwise as an intelligent talking liquid level indicator, or by a like name, that in some implementations may use water or other liquid detection capacitance to detect whether a liquid is present. In many implementations, devices hereof may be used to detect and/or alarm or feedback to prevent spillage of chemicals such as solvents in laboratory waste container.

There are numerous methods and apparatuses for sensing and/or communication, systems and devices known that are used for sensing liquid levels and communication notifications between and among users. However, desiderata remain for one or more of improved flexibility and/or functionality in sensing and communicating liquid levels, particularly toward reducing harmful overflows. The presently disclosed developments may be implemented meet these and/or other sensing and communication needs.

### SUMMARY

Disclosed are one or a variety of sensor indicators that include intelligent talking liquid level indicators, which in some implementations may be based on the detection principles of capacitance and/or induction and/or ultrasonic or optical or integrated with a unique algorithm. They can achieve intelligent recognition, and can correctly indicate the liquid level status whether the level is liquid or non-liquid, as for example some powders. It is also noted that many liquid level indicators are based on some contact between the sensor and liquid, and though some implementations herein may include such contact, the preferred type of sensor in many implementations herein are non-contact, where the sensor never comes in contact with the liquid. This is why such are called a “non-contact” liquid level sensors.

This sensor indicator which may also be referred to in some instances as a talking liquid level indicator can work with any kinds of liquid. Especially toxic substances, strong acid and alkali, the liquid level indicator can work in any kind of nonmetallic container.

Included herein are devices, systems and/or methods for liquid level sensing and communication and/or alerting including:

a sensing sub-system for sensing liquid level sensing, and,

a communication sub-system for indicating a result of the liquid level sensing.

Alternatives include devices, systems and/or methods for liquid level sensing and communication and/or alerting, the sensing sub-system including a non-contact sensing system for sensing a liquid level without contact of the sensor with the liquid.

Further alternatives include devices, systems and/or methods for liquid level sensing and communication and/or alerting, the communication sub-system including an alert with beep and/or voice and/or light indication.

Still further alternatives include devices, systems and/or methods for liquid level sensing and communication and/or alerting, the sensing sub-system including a capability of learning empty parts of the container.

Yet still further alternatives include devices, systems and/or methods for liquid level sensing and communication and/or alerting, with a capability of learning empty parts of the container including learning and memorizing the empty portion of the container.

Alternatives may also include devices, systems and/or methods for liquid level sensing and communication and/or alerting, with a capability of learning empty parts of the container including a capability to test the unit to make sure it will react by beeping, or providing some audio (or visual) alert to the filled portion of the same container.

Further alternatives may include devices, systems and/or methods for liquid level sensing and communication and/or alerting, with a capability of learning empty parts of the container including pushing the on/off button a number of times to learn the empty part of the container.

These and still further aspects as shall hereinafter appear are readily fulfilled by the present developments in one or more remarkable and/or unexpected manners as will be readily discerned from the following detailed description of exemplary implementations thereof especially when read in conjunction with the accompanying drawings in which like parts bear like numerals throughout the several views.

### BRIEF DESCRIPTION OF THE DRAWINGS

FIG. 1 is a perspective view of an implementation of the combination of a device and some details hereof incorporating one or more features of the present developments.

FIG. 2 is a perspective view of a device hereof, showing various components of the device, as configured for use.

FIG. 3 is a perspective view of a device as disclosed herein.

FIG. 4 is a perspective view of a device as disclosed herein incorporating the features of the developments.

FIG. 5 is a schematic view of a device hereof.

FIG. 5A is a schematic view of an alternative implementation of a device hereof.

FIG. 6 is an exploded view hereof.

FIG. 7 is an exploded view hereof.

FIG. 8 is an exploded view hereof.

FIG. 9 is an electronic schematic hereof.

FIG. 10 is a plan view of an alternative hereof.

FIG. 11 is a perspective view of the device hereof, showing the various components of the device, as configured electronically and laid out in extended format for clarity.

FIG. 12 is a schematic view of the device showing the details of the electronic circuit board with the components laid out in extended format and as disclosed herein.

FIG. 13 illustrates an exemplary computer system or computing resources with which implementations hereof may be utilized.

FIG. 14 provides a methodology for operating the device hereof.

### DETAILED DESCRIPTION OF THE DEVELOPMENTS

The present developments relate to systems, devices and methods used for sensing liquid, colloid, and powder levels and communicating notifications to, between and among users. In some respects, the sensing device may be attached or placed on a bottle or other container. In one implementation, this may be performed by using a nylon strap or belt and buckle, and in some instances this strap may have some elastic properties which allows the strap to support the device, yet securely hold the device against the container on which it is placed. Moreover, the developments hereof relate to a variety of apparatuses typically configured to provide audio and visual alerts to a user of such an apparatus to prevent overfills, spills, or other accidents that may occur when a container is overfilled in a variety of settings, such as laboratory or chemical facility, where the handling of liquids, colloids, and powders is a regular activity. Furthermore, the developments hereof relate to the use of electronically enabled technology to facilitate the alerting of users of such an apparatus and methods of communicating alerts from such a device to and among users.

A device hereof may include a substantially flat or substantially planar housing, package or device for sensing liquid or powder level and communication of a signal related thereto, the sensing in some implementations including capacitance or inductance or other liquid or powder sensing and the communication including one or more or a combination of digital sound recording unit such as a digital sound magnetic recording unit, a digital sound storage and playback unit, a microphone, a speaker and optionally, an LED indicator, an audio indicator or a combination thereof, and a cover for containing the combination of the components. The housing may include an upper and lower covers attached thereto, and configured to enclose the sensing and communication parts/units.

Devices hereof may be suitable for many common waste containers, such as bottles, jars, jugs or the like. The devices hereof can be removably or fixedly or adjustably disposed adjacent a top portion of the container. When liquid reaches the device sensor level, an alarm will be sounded and/or lit and may include a voice urging the laboratory personnel to empty the container. Prevention of chemical overflows can provide higher degrees of lab safety which may reduce and/or minimize risks to lab personnel and their environment. A talking electronic liquid level indicator or other developments hereof may be economically efficient with better safety, reduced fire risk, no overflow, no cross contamination, and no personnel exposure to hazardous solvents and ultimately a happier and healthier work environment.

Still further alternatives may include devices, systems and/or methods for liquid level sensing and communication and/or alerting, with a capability of learning empty parts of the container including pushing the on/off button six (6) times to learn the empty part of the container.

Additional alternatives may include devices, systems and/or methods for liquid level sensing and communication and/or alerting, the devices, systems and/or methods being utilized on plastic or glass or similar containers, though not generally metal containers, unless the metal has a hole insert a u-shaped device into the hole and the device, system or method is operable relative to the u-shaped device.

In one implementation, the present developments relate to a talking electronic liquid level indicator, or an intelligent talking liquid level indicator that uses one or more of water, liquid, colloid, and powder detection capacitance to detect whether the said water, liquid, colloid, and powder is present. For example, when the liquid does not touch or otherwise come within the detection of the detector, there may be disposed a static capacitance due to distributed capacitance existing in the detector. Some capacitive liquid level sensors use a technique where the sensor is located outside the liquid container. When the liquid level rises and reaches the test point (aka “TP”) of the detector, the stray capacitance of the liquid will be coupled through the TP end of the detector, so that the capacitance value of the detector will change and gradually increase. Thus, the signal will be sent to the MCU (micro-controller unit) customized as described herein, and then converted into an alarm signal which may include one or more lights from one or more LEDs or the like and/or may include sounds such as beeps and/or a voice signal to the speaker to send out the liquid level alarm sound.

While the developments hereof are amendable to various modifications and alternative forms, specifics hereof have been shown herein by way of non-limitative examples in the drawings and the following description. It should be understood, however, that this is not to limit the developments hereof to the particular implementations described. This is instead to cover all modifications, equivalents, and alternatives falling within the spirit and scope of the developments whether described here or otherwise being sufficiently appreciable as included herewithin even if beyond the literal words or figures hereof. Furthermore, while the descriptions and details describe what is presently considered to be certain implementations of the developments, it will be understood that various modifications may be made therein, and it is intended to cover in the appended claims all such modifications as fall within the spirit and scope of the developments.

In one implementation, the present application discloses a device for liquid level sensing and indication or communication using one or more of lights, sounds and/or voice messaging, the device comprising a substantially thin shaped housing unit comprising:

a front cover, a back cover and one or more side walls connecting the front cover with the back cover (the housing may be relatively flat or may be curvilinear for bottle use);

a non-intrusive liquid sensing element;

an indicator or communication unit for indicating or alerting the presence of a liquid at a particular level, including one or more of:
a light emitting device (which may be an LED) indicator, and/or
an audio indicator, or a combination thereof, including one or more of:
   a digital sound unit configured for activating/playing and/or recording a message to be played;
   a digital sound storage unit;
   a playback unit that may include a speaker.

Optionally, other features may be included such as a power supply or connection, a calibration functionality and/or a manual ON/OFF switch for turning on and turning off the device when the device is not in use. Also optionally, the sound unit which may include a recording unit, and a sound storage unit, playback unit, a microphone and speaker may be configured to allow a user to record a message and playback the message using manual or other types of switches. In other alternative implementations a battery may be used to power the device.

As used in the present application, the sensing can be used on a variety of containers which can be liquid containers of many types. Commonly, the devices hereof may be disposed or disposable on bottles, or like standing and/or possibly though not necessarily portable containers, but, may also be used in/on other container types also and not limited to, sinks, tubs, pipes, and/or containers. For example, the device can be attached to a pipe at a factory or a refinery, or the like. As used herein, the term “bottle” may also include a plastic bottle or a glass bottle, that are typically used to store and transport consumer goods and products known. The device may be attached to the side or back of the bottle, and may be used to sense liquid levels and/or to provide information, instructions and or advertisement on the product or other products. Because of the curvilinear configuration of the surface of a “bottle”, as used herein, an equivalent of a “bottle” and the substantially equivalent function of such a bottle. Accordingly, the bottle or can may also serve to store or contain various solids, colloids (gels), and liquids known, in many implementations such as chemicals in a laboratory setting, particularly such as solvents, but, may also be used in other areas including liquids such as carbonated soda, noncarbonated drinks, wine, liquors and the like. In another implementation, the device may also be attached to larger format bottles and cans, such as glass, wood, metal or plastic drums and carboy for liquid and solid food products or chemicals, such as hazardous chemicals that may be useful with having appended information or instructions, by using the device of the present application. Non-limiting examples of such drums include 20 gallon drums and 55 gallon drums.

In a first implementation, the present developments relate to a device 500 also in some instances known as a Talking Electronic Liquid Level Indicator, TELLI, or an Intelligent Talking liquid level indicator that in this first implementation uses non-intrusive detection capacitance to detect whether one or more of water/liquid/colloid/powder is present. When the one or more of water/liquid/colloid/powder does not reach the detector, there is static capacitance due to distributed capacitance existing in the detector.

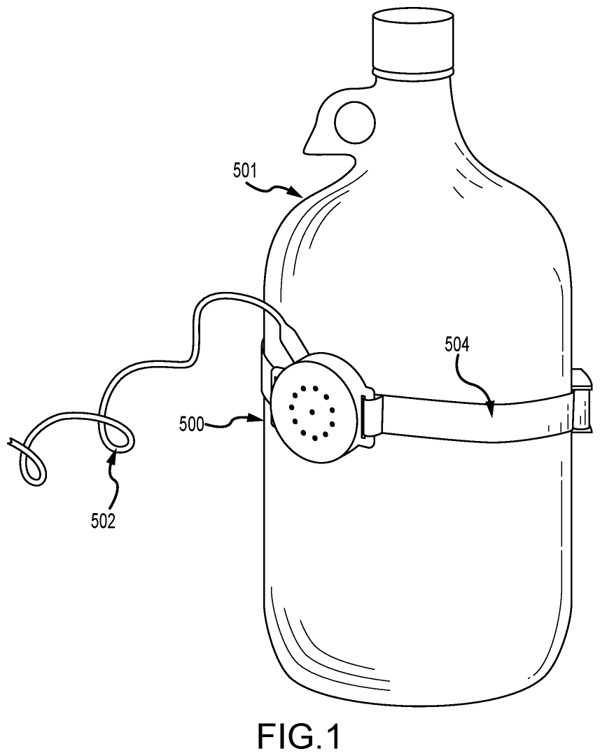

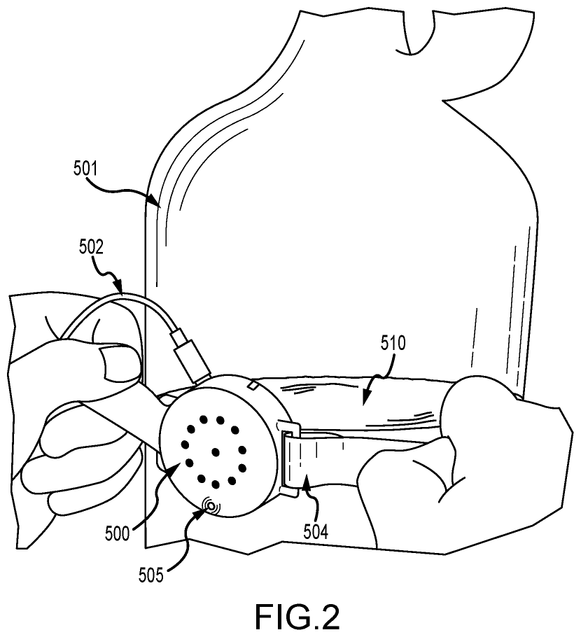

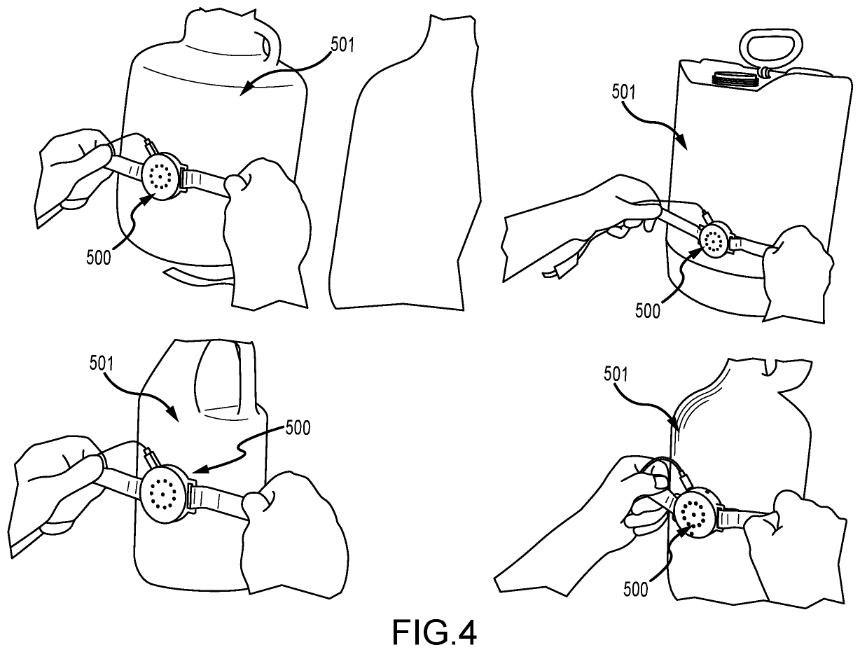

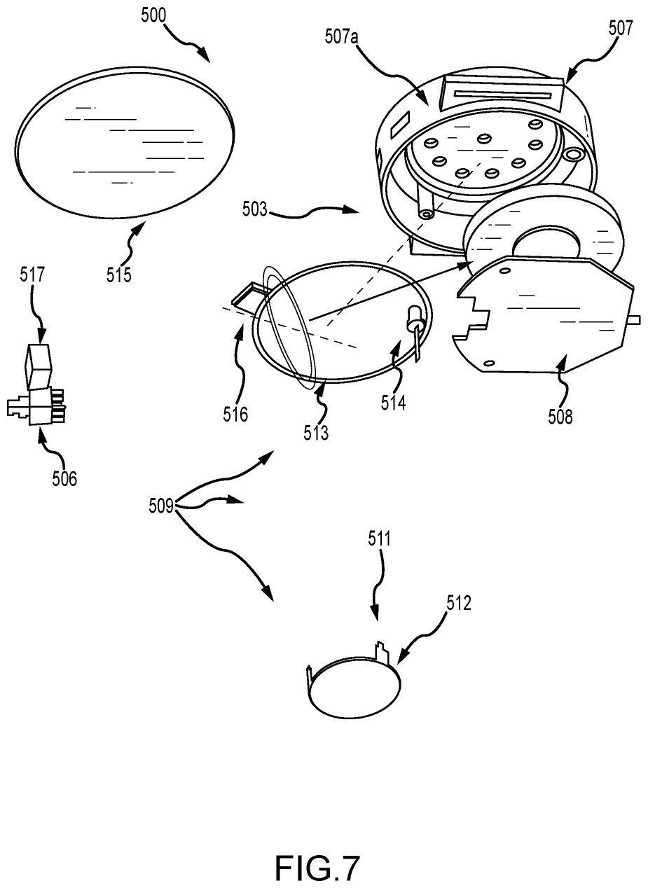

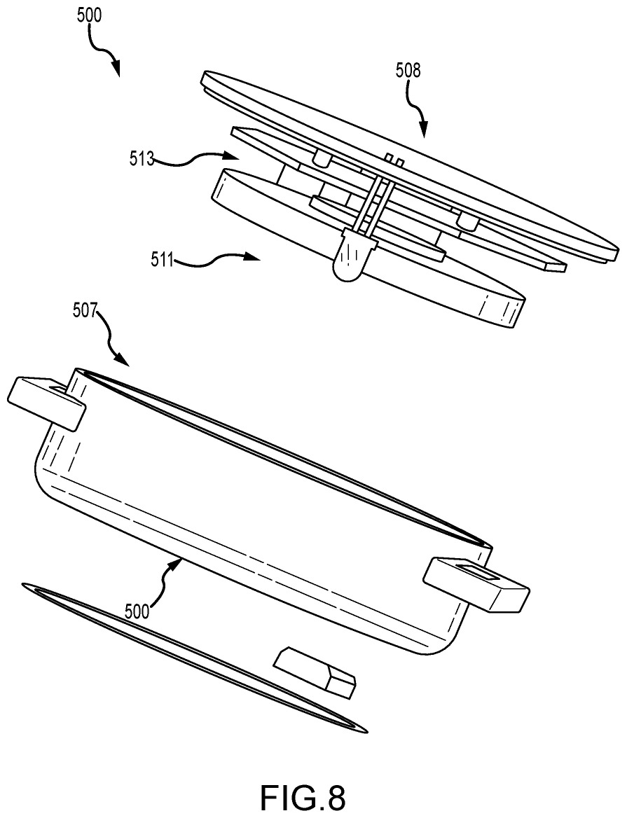

This device 500 is in this first implementation (as shown and described relative to FIGS. 1-8, inter alia) designed to prevent spillage of chemical in laboratory waste container, here shown in FIG. 1, inter alia, as a bottle 501. A waste container 501 can be a 4 Liter Glass or plastic bottle or larger (or smaller) containers; a variety of non-limiting containers 501 are shown receiving a device 500 hereof in FIG. 4. This device 500 works on clear glass bottles, plastic containers and semi-metal bottles. It can detect liquid, colloids, and/or powder being poured or flowed into bottles, or other containers. The device has memory. Generally, an equilibration procedure is part of the use of such a device 500 on the empty portion of the bottle 501 and by, in an example, pressing the on/off button six times and then push the on button and letting the device operate as designed and intended. To test if the device is working a user can move the talking liquid level indicator 500 down as shown in FIG. 2, toward the liquid level and test the unit 500. If sound is in itself or is at least part of the alarm communication, the sound unit starts beeping and may be followed by an instructional voice (female or male) asking a user to empty the container 501. This will continue until the sensor device 500 is moved up, so called snoozing the process, or until the container is safely emptied. A light 505 as shown in FIG. 2 might also be used as part of the communication indication.

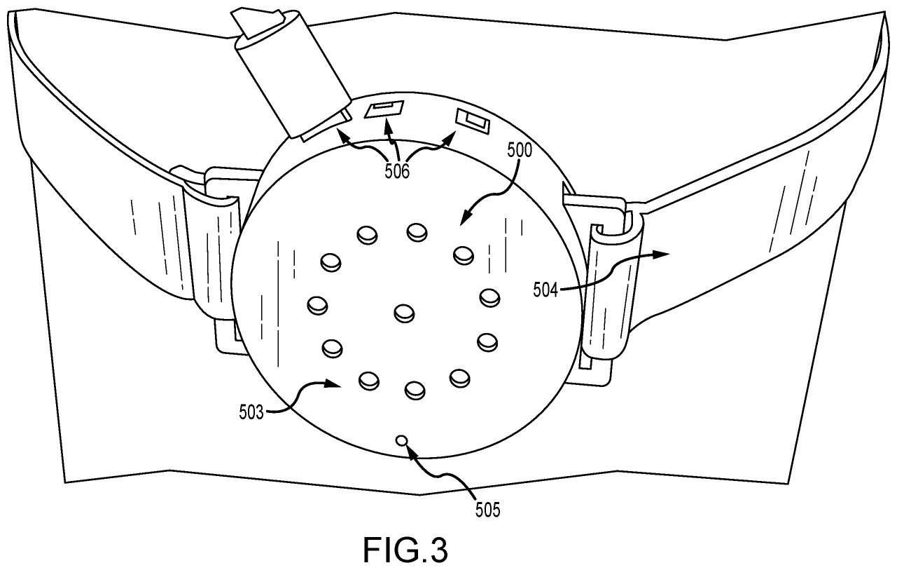

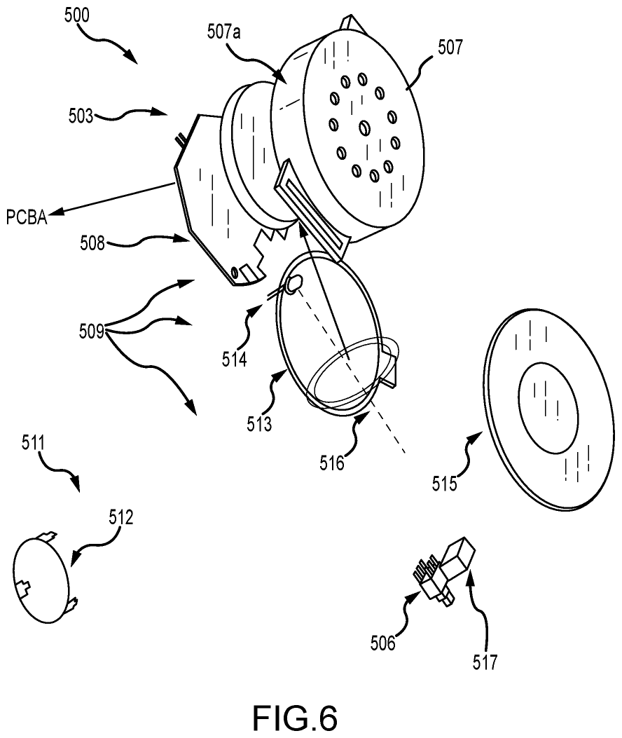

Also shown in FIGS. 1 and 2 are a power supply 502 and a connective device 504. The power supply could be internal, such as a battery, not shown or provided by supply line, here a USB cable 502. Shown is a band 504 for the connection of the overall device 500 to a container 501, and though this might be alternatively elastic or like material, other connection types might also be used as with a buckle (as shown) or otherwise. Indeed, other connection mechanisms or processes might be used instead or in addition, as for example one or more suction cups, Velcro® strips, double-sided tape, removable or replaceable adhesive sticker, or like devices for connection to a glass bottle or the like. The housing 503 is generally indicated in FIG. 3; the housing containing the sensor and communication elements (not separately shown in FIGS. 1-5, but, see FIGS. 6-9 described below).

As noted, an indicator light 505 is identified in FIG. 2, but, is also shown in FIG. 3. It might be that one or more lights might be used for different significance. For example, a red light might be used when a liquid level is sensed (e.g., FIG. 2), or for example, a green light might be used (FIG. 3) to signify that the device is properly turned on and powered up and thus ready to sense a liquid. FIG. 3 also shows a couple of additional/optional features 506, such as switches or connections, inter alia. One feature 506 might be an on/off switch or button, another might be a calibration button, though the on/off switch/button might be configured/configurable to perform both functions. Another feature 506 might be a power connection, as here where a USB connection device is shown/used.

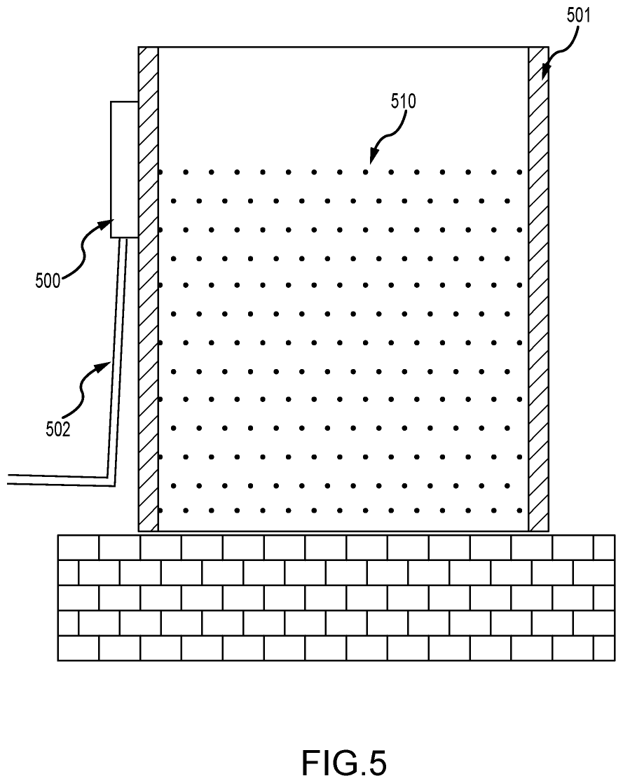

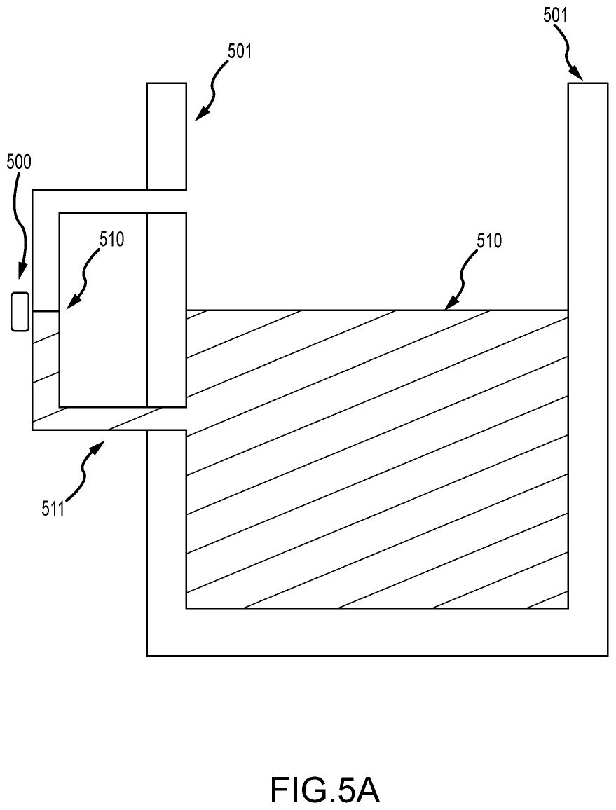

A more schematic cross-sectional view is shown in FIG. 5, where a device 500 is shown operatively disposed relative to (or on) a container 501. A power supply line 502 (here indicated, in this example, as a DC Input (USB-A)) is also shown. A liquid level 510 is also shown more clearly in FIG. 5 (but see indication in FIG. 2 as well).

FIG. 5A shows an alternative implementation of a device 500 in use on an alternative container 501 that here may be of metal, or partly metal or of lager scale wall size such that a device 500 hereof might not be appropriately capacitively reactive to the liquid level 510 in the container 501. In such case, a tube 511 or similar apparatus might be configured to be disposed with one or more through holes to allow the liquid level 510 to be realized outside the container 501 as shown. Then, disposition of a device 500 on the tube 511 can provide the sort of liquid level sensing as described herein elsewhere. The tube 511 might thus be of a particular material, e.g., plastic or glass or similar that would readily allow the capacitive non-contact liquid level sensing as described throughout.

FIGS. 6-9 show many multiple component parts of a device 500, mostly those contained within a housing 503, generally. An outer housing part 507 and a back side housing part 508 come together to form the housing 503, with a side wall 507a of outer housing 507. A plurality of interior elements 509 are shown in exploded views in FIGS. 6, 7 and 8. Included generally are a sensor unit 511 and an indicator or communication unit 513. The sensor unit 511 includes at least a liquid level sensor 512, and the communication unit 513 may include one or more of a light 514, a speaker 515 and a sound unit 516. The sound unit may simply have pre-recorded sounds thereon or may include a microphone or other input mechanism and or recording arrangement, not shown. Switching 506 and microcontroller unit (“MCU”) 517 are also indicated generally.

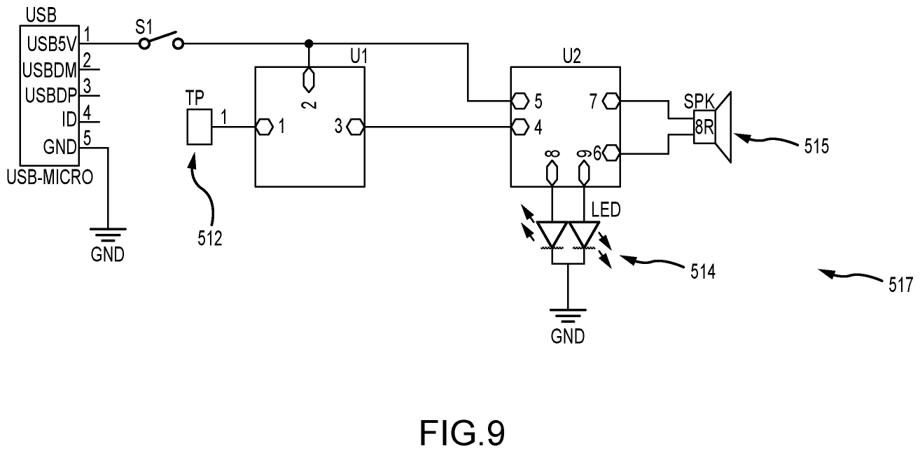

FIG. 9 includes an exemplar of one alternative of an MCU (microcontroller unit) 517 that includes controls for the speaker 515 and LED 514 based on input from the sensor 512. Less or more elaborate controls might be used.

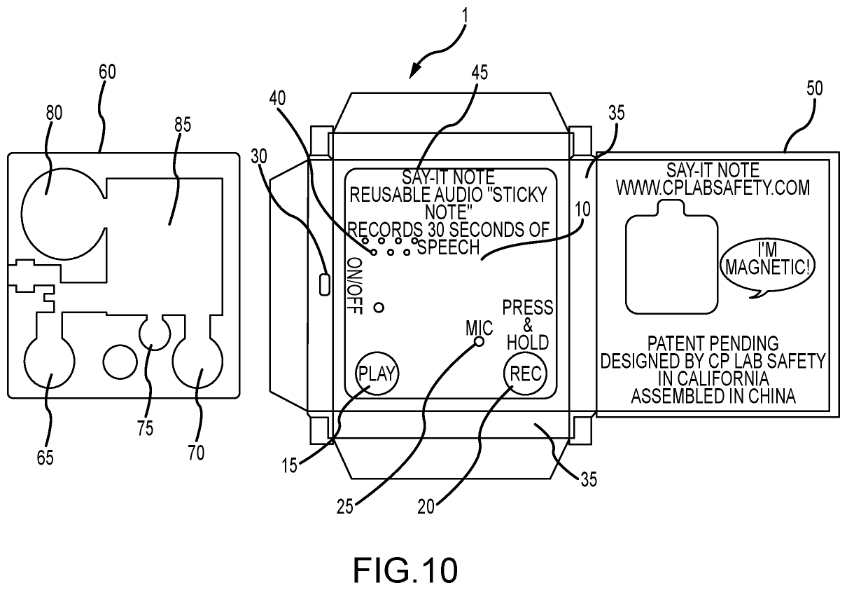

In many implementations, features of the system, device, or method being suitable for glass, plastic bottles, or semi-metal containers. In at least some implementations, the On/Off button or switch 30, as shown in one implementation in FIG. 10, may provide for some programmability, adjustability, reset-ability, to enable the system or device to be able to be programmed or adjusted to a new container or bottle. In at least some implementations, the system, device or method hereof is capable of one or more of detecting and sensing liquid, colloid, and powders. When a liquid, colloid, or powder reaches the device level, the speakers will emit a sound, or start beeping multiple times, and in at least some instance may be followed by a voice asking to empty the container, or to stop the flow of the substance in to the container. One feature may be that very low voltage may be utilized to power the system, such as through a USB to mini-USB cord connecting power to the device. Another feature may be that the unit does not spark or shock as tested by Underwriter Laboratories, thus being capable of being certified as UL.

The system, method, device, or apparatus hereof may provide numerous benefits including one or more of the following: preventing overflow solvent situation; preventing, reducing, and eliminating over-flow and thus eliminating evaporation into a lab or other working environment; preventing, reducing, and eliminating overflow and thus stopping solvent cross contamination; reducing personnel exposure to toxic chemicals; reducing fire risk in the instance that the solvent is a fire risk; alerting users to potential overflow or high levels of a liquid in a container; promoting a safer, healthier, more enjoyable environment, especially when used in a laboratory environment.

The device and developments hereof assist, provide, and promote more attention to lab safety. The device 500 hereof also sometimes referred to as a TELLI-01 liquid level indicator may be part of a solution, implemented by end users who desire to prevent accidents at their facilities or labs. Purchasing, installing, and using a TELLI-01 may help management send a clear message to the laboratory personnel that safety is taken seriously.

The device, systems, and apparatuses hereof are suitable for most common waste containers. It can be reset by pressing on/off button 30, as shown in FIG. 10 inter alia, 6 times on the empty top portion of the container. When liquid reaches the device, several sharp beeps will be heard followed in a least some instances by a voice urging the laboratory personnel to stop the flow or the liquid and/or empty the container. The liquid level indicator operates on low voltage and is UL tested and approved for laboratory safety. Lab Safety is all about reducing and minimizing risks to lab personnel and their environment. The system, device, and apparatus hereof may be a low cost solution that provides better safety, reduced fire risk, no overflow, no cross-contamination, and no personnel exposure to hazardous solvents and ultimately a happier and healthier work environment.

A working principle for the intelligent talking liquid level indicator is using liquid detection capacitance to detect whether the liquid is present, when the liquid does not touch the detector, there is static capacitance due to distributed capacitance existing in the detector.

When the liquid level rises and contacts the TP (test point) of the detector, the stray capacitance of the liquid will be coupled through the TP end of the detector, so that the capacitance value of the detector will change and gradually increase. Thus, the signal will be sent to the MCU, and then converted into a voice signal to the speaker to send out the liquid level alarm sound. A non-intrusive fluid level detector including a single point capacitive sensor mounted on the outside surface of a receptacle such that capacitive principles can be utilized to sense the level of a liquid contained within the receptacle. The sensor assembly is disposed in a substantially fixed position on the exterior wall of the receptacle wherein the dielectric effect of the liquid changes the effective capacitance of the sensing capacitor as the liquid rises and falls within the receptacle.

This change in effective capacitance is detected by electronic circuitry included in the detector device. In one embodiment, the fluid level detector is directly mounted to a completely non-conductive receptacle. In another embodiment, the fluid level detector is mounted to a non-conductive window which is an integral part of a receptacle fabricated out of a conductive material.

Further features of the device and developments hereof may include: operating voltage range of: 1.8V-5.5V; 1 channel liquid level indicator unit; Output signal: TTL level; detection electrode (probe): all conductive materials, such as stainless steel needle, copper foil, iron sheet, or others; the device and developments are RoHS compliant; capable of detecting substances such as liquid, powder, particulate matter, etc. and sensing distance up to over 10 mm; a speaker with an approximate size of 40×5.2 mm, 16Ω 25 W; in some implementations the approximate dimensions may be 50×24 mm; the power supply may be using a low voltage power supply which may provide DC power to the device; the device may include a USB power cord approximately 8 feet in length; the device may include a strap, elastic belt, tape, Velco®, adhesive, adhesive sticker or other implement to allow the device to be attached to the container. In the case of a strap, the strap may be made of nylon and in some instance may be 60 cm, or longer, or shorter depending upon the application and circumstances, but should be of a length suitable and capable of securely attaching the device to the container. In some instances the strap or belt may have a buckle or clasp for securing.

The technical parameters of the system, device, or apparatus may include one or more of the following: Input voltage (In VCC): DC 1.8V-5.5V; Current consumption: 4.8 mA; Response time: 500 mS; Working temperature: −40-85 degree C.; Induction thickness (sensitivity) Range: 0-20 mm (adjustable); and for use with container materials including plastics, glass, ceramics, and other containers.

In some implementations, a number of presses of the button 30 may be used for one or a variety of functions. For example, a selected number of depressions of the button may be used to educate the device as to an empty state of the container. One such desirable number of button depressions is six times, selected to be sufficiently more than one or two or three or like number of accidental depressions that could occur during positioning of the device, but, not so many as to be unduly cumbersome. Even so, the number of depressions for such a calibration event could be more or less than six depending upon preselected desired programming. In at least some implementations the pressing of the button 30 will cause the speaker to emit a sharp beep to indicate to the user that the button as been depressed, thus allowing the user to know that the pressing of the button has registered with the device.

For the sound unit or system described herein; particularly as may be used to provide a communication unit and/or functionality as described herein above; an implementation may include the following as shown and described relative to FIGS. 10-12. In these implementations, the sound system may be referred to also or alternatively as a Digi-Note or personal and/or interpersonal messaging device.

In one implementation, the present sensing and sound alert system may include a portable, interactive device for personal or interpersonal non-video communication using voice messaging comprising a substantially thin polylateral shaped housing unit comprising:

a front cover, a back cover and side walls connecting the front cover with the back cover;

a digital sound recording unit configured with a manual switch for activating and recording a message;

a digital sound storage unit;

a playback unit configured with a manual switch for activating and playing back the recorded message;

a microphone; and

a speaker; and optionally,
a light emitting device (LED) indicator or an audio indicator or a combination thereof, for indicating or alerting the presence of a recorded message; and/or
a manual ON/OFF switch for turning on and turning off the device when the device is not in use; wherein the sound recording unit, sound storage unit, playback unit, microphone and speaker are configured to allow a user to record a message and playback the message using the manual switches.

In another implementation, the present application discloses for the communication part of the sensing/sound system, an interactive device for personal or interpersonal non-video communication using voice messaging comprising a substantially thin, curvilinear housing unit that is attached to a bottle, the device comprising:

a front cover and side walls connecting the front cover with the outer surface of the bottle;

a digital sound recording unit configured with a manual switch for activating and recording a message;

a digital sound storage unit;

a playback unit configured with a manual switch for activating and playing back the recorded message;

a microphone; and

a speaker; and optionally,
a light emitting device (LED) indicator or an audio indicator or a combination thereof, for indicating or alerting the presence of a recorded message; and/or
a manual ON/OFF switch for turning on and turning off the device when the device is not in use; wherein the sound recording unit, sound storage unit, playback unit, microphone and speaker are configured to allow a user to record a message and playback the message using the manual switches.

In yet another variation of the above implementations, the present application discloses a portable, interactive device for sensing liquid levels with a communication system including one or more of a personal or interpersonal video and/or audio communication using video and voice messaging comprising a substantially thin polylateral shaped housing unit, as disclosed herein. In yet other variations the device is WiFi enabled and can text message or send push notification to the user as for example, WiFi enabled “Push Notification” messaging through a user's smart phone and/or may include communication to and/or through the Internet of things (IOT). Moreover, a surface of a device hereof may include alternative messaging types, as for example, display or broadcast or transmission of information and/or alarm and/or notification of electronic or electromagnetic presentations such as light emitting diode (LED) presentations, or other electronic presentation forms providing visual or aural (or other sensory) signals (as for example, liquid crystal display (LCD), plasma or other presentation forms) or Bluetooth or the like or i-beacon, or Bluetooth Low Energy (BLE) or another low-power or lower frequency version of Bluetooth, such presentations perhaps providing scrolling, static, flashing, random and/or updateable custom messaging, such messaging alternatively being programmable and re-programmable on particular devices or being set such that alternative messaging is provided by replacing the LED or other electronic presentation or communication part of the device. Re-programmability might include an ability to broadcast or near-cast a programming or programmed signal to or from one or more electronic presentation/communication devices simultaneously or serially. Radio Frequency (RF) signals could also/alternatively be usable here. RF Identification (RFID) could be useable herefor. Presentations aurally could be sent via one or more sensor/indicator apparatuses to an individual user via the airspace between the user and the sensor/indicator device, or to listening device such as a headset or an earbud. The listening device could be radio frequency enabled to receive radio frequency signals from the advertising apparatus, such as being an AM or FM or like or other radio device. Any of these could be used for general alarm mode, or other information communication. Or, as indicated, the alarming or other information may be communicated to and/or through Wi-Fi or local area communication to the internet or to a local receiver for processing and/or data collection and/or communication. Thus, communication and/or data collection can occur through a variety of known and/or to be developed data communication systems and/or hardware whether locally, as for example within a room, or within a few near rooms, or within a building, and/or possibly off-site, whether to other parts of a building or campus, or further.

As used in the present application, the term “bottle” may also include a plastic bottle or a glass bottle, that are typically used to store and transport consumer, commercial, or industrial goods and products known. The device hereof may be attached to the side or back of the bottle, and may be used to provide information, instructions and or advertisement on the product or other products. Because of the curvilinear configuration of the surface of a “bottle”, as used herein, an equivalent of a “bottle” and the substantially equivalent function of such a bottle, may also be a can, such as an aluminum can. Accordingly, the bottle or can may also serve to store or contain various solids and liquids known, such as carbonated soda, noncarbonated drinks, wine, liquors and the like. In another implementation, the device may also be attached to larger format bottles and cans, such as glass, wood, metal or plastic drums and carboy for liquid and solid food products or chemicals, such as hazardous chemicals that may be useful with having appended information or instructions, by using the device of the present application. Examples of such drums include 20 gallon drums and 55 gallon drums.

In another implementation, there may be provided a method for liquid level sensing and communication including recording and playing back an audio recording of a recorded voice message using the above cited portable, interactive device for liquid level sensing and personal or interpersonal non-video communication using voice messaging as described herein.

For some implementations including a communication system with spoken voice alerts, included may be an inexpensive, re-usable or multi-use, light weight portable messaging device, that may be referred to as SAY-IT NOTE™, DIGI-NOTE™ and VOYC MEMO™ (or VOYCE MEMO™), may be used in place of, in conjunction with or supplemental to, a sticky note or a Post-it Note®, but by using the messaging device as disclosed herein, the user may record a short, unique or personalized voice message for the liquid level alert. And the device containing the message may be left at a particular location for the receiver to readily view and retrieve the message.

Accordingly, once the message is recorded onto the device, the device may be moved or brought to a preferred liquid level sensing location or the device may be left at or remain at the original location for the message recipient to receive the message. Once a message is recorded onto the device, an LED indicator may be used to turn on or blink to indicate a new message has been recorded onto the device. As used herein, the optional audio indicator may be employed using the same or different speaker, or using a sound generator such as a sound generator chip (e.g., a Sound Generator IC) to generate or emit a sound, such as a beep, at different intervals, to indicate the presence of a recorded message.

In one variation, the device comprises an electronic memory unit or a memory device, or a storage device, that stores electronic signals, a mechanism for retrieving the electronic signals from the memory unit, memory device or storage device, a voice synthesizer which retrieves the electronic signals and produces audible sounds or message that is representative of the message, such as the personalized message. In another variation, the device may also comprise a pressure activated control or switch, such as a manual switch that, when activated by pressing an external button or switch, controls the retrieving device and the voice synthesizer to play back the stored message. In another variation, one or more manual switches may be used to activate the sound based on the stored message, resulting in the pre-recorded audio file of the message to play back.

In one variation, the digital sound recording unit is a digital magnetic recording unit. In another variation, the sound recording and storage unit allows a short sound or audio recording of a message for about 60 seconds, 45 seconds, 30 seconds, 15 seconds, 10 seconds or less. In another variation, the sound recording or storage unit allows for a sound or audio recording of a message for about 30 minutes, 20 minutes, 10 minutes, 5 minutes or about 2 minutes.

In one variation, the recorded message is stored in digital format, such as a compressed digital format. In another variation, the sound storage unit erases the recorded message after one playback or replay, or two playbacks. In another variation, a second or subsequent recorded message overwrites the first or earlier message or messages. In yet another variation, the recorded message may be stored and replayed. As used herein, the recorded message may be erased or over written with the recordation of a second or subsequent recorded message.

In one variation, the manual record switch (or record button) 20, as shown in FIG. 10, is pressed once to initiate the recording and the manual record switch is maintained depressed to continue recording until the user is complete with recording, in which case, the user releases the switch to stop the recording. In another variation, the manual record switch 20 is pressed and then released to start recording the message, and when the recordation of the message is completed, the manual record switch 20 is pressed again to stop recording.

Referring to one implementation of the developments as shown in FIG. 10, the device 1 comprises a front cover 10, a back cover 50, and side walls 35 that comprise the housing unit of the device. In one variation, the front cover 10, back cover 50 and side walls 35 may be made from a plastic or firm paper or cardboard, or a combination thereof. The front cover may be configured with a manual switch 20 for activating or recording (REC) a message, and a manual switch 15 for activating and playing back (PLAY) the recorded message. In this particular implementation, the front cover 10 may be configured with a microphone (MIC) 25 for recording the message, and speaker openings 40 for providing clear audio during play back of a message. In one variation, the sound volume is adjustable with a volume control knob or switch (not shown in the figures) such that the recording volume may be increased or decreased. Depending on the desired commercial application(s), the front cover provides an area or a space 45 useful for providing information or advertising, such as marking with a company's name, logo, website, or a trademark name, such as SAY-IT Note™, DIGI-Note™ or VOYC Memo™. Similarly, the back cover 50 of the device 1 provides a space for placing a magnet (identified as “I'm magnetic”, but not shown) for attaching onto metal surfaces, or for incorporating a low, medium or high tack adhesive (not shown) for re-adherable or removably attach the device to a variety of different surfaces. As shown in FIG. 10, a manual ON/OFF switch 30, for turning the device on and off, may be incorporated into one side of a side wall, 35.

Referring to FIG. 10, the device may also comprise an internal, insertable component housing unit 60, which may be made from paper board or molded plastic, with various carved out, partitioned or templated depressions in the component housing unit 60 for securely holding the various electronic components in place, such as a space for holding the manual play back switch 65, a space for holding the manual recording switch 70, a space for holding the microphone 75, a space for holding the speaker 80, and a larger space 85 for holding an electronic memory unit or a memory device (not shown), or a storage device (not shown) that stores electronic signals, a mechanism for retrieving the electronic signals from the memory unit, memory device or storage device, a voice synthesizer and electronic connections or links that connects the various components in the device, including the record and play back switches, microphone, speaker and power source, etc. In some implementations, the housing unit may be flexible and deformable allowing the housing to more easily take the shape of the container to which it is attached.

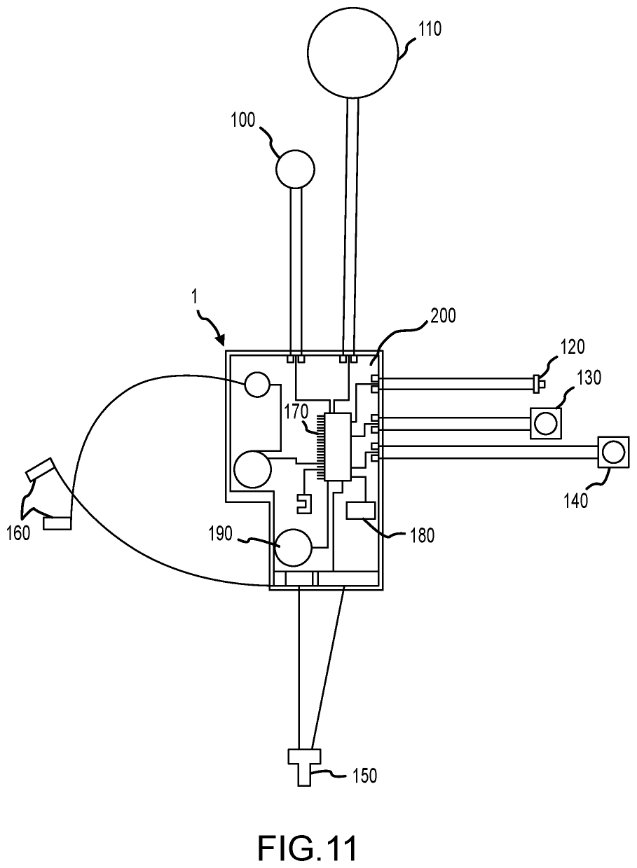

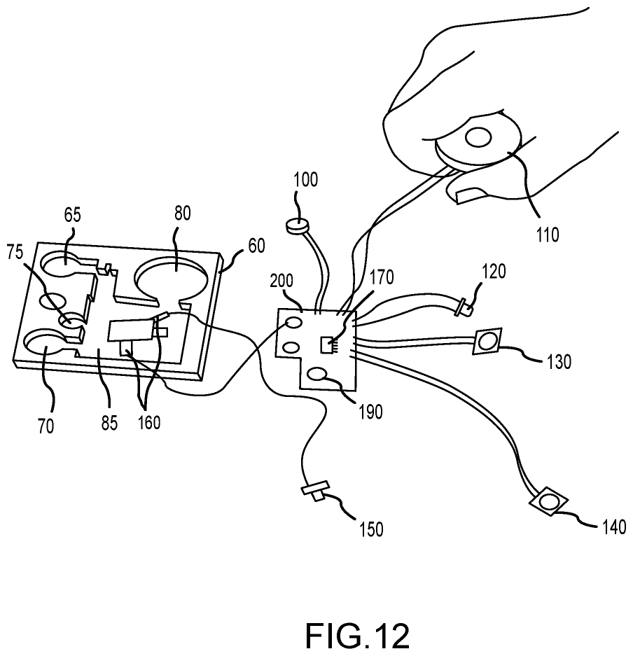

Referring to one implementation of the developments as shown in FIG. 11, the components of the device 1, as configured electronically and laid out in extended form, comprises a microphone 100 for receiving a message, such as a voice message; a speaker 110 for replaying the message; optionally, a light such as an LED light 120 that may be a constant or flashing light, for indicating the presence of a stored or recorded message; a recording switch 130 such as a manual recording switch or pressure sensitive recording switch, for manually activating to initiate or start a recorded message; a playback switch 140 such as a manual playback switch or pressure sensitive playback switch, for manually activating to playback or start a playback of a recorded message; an ON/OFF switch 150 for turning the device on when in regular use, or turning the device off when not in use for extended period of time; a battery and battery terminal 160 employed as a power source for operating the device; an integrated circuit chip (IC chip) 170; an electrolytic capacitor 180; and battery position 190. As shown schematically in FIG. 11 and shown in one implementation of the device in FIG. 12, the device further comprises an electronic circuit board 200, such as a printed circuit board, for holding, supporting and electrically connecting the above cited electronic components with conductive tracks, pads and related features of the electronic circuit board for connecting an electronic memory unit or a memory device, or the storage device, the mechanism for retrieving the electronic signals from the memory unit, memory device or storage device, the voice synthesizer.

Referring to one implementation of the developments as shown in FIG. 12, the device comprises a microphone 100 for receiving a message, such as a voice message; a speaker 110 for replaying the message; optionally, a light such as an LED light 120 that may be a constant or flashing light, for indicating the presence of a stored or recorded message; a recording switch 130 such as a manual recording switch or pressure sensitive recording switch, for manually activating to initiate or start a recorded message; a playback switch 140 such as a manual playback switch or pressure sensitive playback switch, for manually activating to playback or start a playback of a recorded message; an ON/OFF switch 150 for turning the device on when in regular use, or turning the device off when not in use for extended period of time; a battery and battery terminal 160 employed as a power source for operating the device; an integrated circuit chip (IC chip) 170; and battery position 190. As further shown in FIG. 12, the device may also comprise an internal, insertable component housing unit 60, which may be made from paper board or molded plastic, with various carved out, partitioned or templated depressions in the component housing unit 60 for securely holding the various electronic components in place, such as a space for holding the manual play back switch 65, a space for holding the manual recording switch 70, a space for holding the microphone 75, a space for holding the speaker 80, and a larger space 85 for holding an electronic memory unit or a memory device, or a circuit board 200.

In one variation, the manual record switch and playback switch is configured to be co-planar with the front cover or flat on the surface of the front cover. In another variation, the manual record switch and playback switch is imprinted with a notation, trademark, words or color, or a combination thereof, to indicate the location of the record switch and the playback switch for ease of pressing and activating to record a message or playback a message. In another variation, the device comprises a power source, such as a battery, including, for example, a rechargeable battery such as a lithium battery. In another aspect, the power source is connected to a charger for charging the device. In another variation, the device may be equipped with one or more USB ports, such as a USB-A, Quick Charge USB or USB-C to charge the device.

In one variation, the device is not a cell phone, a smart phone or a tape recorder. In another variation, the device is a standalone device and excludes any video recording or video playback or multimedia function or capacity. In another variation, the device is not internet or web enabled or accessible for communication, and excludes any voice over internet protocol configurations. In another variation, the device is configured without a video screen such as those on a cell phone or smart phone.

In one variation, the LED indicator is a light indicator for indicating a liquid level, or that the device is on and/or operable or that may be continuously on when there is a recorded message, or a blinking light indicator to indicate the presence of a recorded message. In another variation, the frequency of the blinking light indicator is 1 blink per 2-3 seconds or 1 blink per 4-5 seconds. The light indicator, either in a blinking mode or continuously on, will remain on until the user retrieves or play back the recorded message. In one variation, the blinking light indicator is configured on the front cover. In another variation, the speaker is configured either on the front cover or the side wall. In yet another variation, the microphone is configured or placed on the front cover or the side wall. In another variation, the ON/OFF switch is configured to be placed on the side wall of the device.

In one variation of the device, the device comprises a processor, a first module for controlling the processor to record and store a message, and a second module for controlling the processor to playback a message. In another variation, the processor is configured to control the recording unit, the sound storage unit, the playback unit, the microphone and the speaker.

In another aspect of the above device, the device is circular or the device is a polylateral shaped housing unit is a quadrilateral housing or trilateral housing unit. Accordingly, where the housing unit is a quadrilateral housing or trilateral housing unit, the shape of the device is the same as the housing unit.

In another aspect of the device, the quadrilateral is selected from the group comprising of a rectangular, a square and a rhombus. In another aspect of the device, the housing unit is a square or rectangular shaped. In yet another aspect of the device, the size of the housing unit is about 3 inches by 3 inches, or about 3 inches by 5 inches, and a width of about ¼ inch. In another variation, the device is substantially the size of 1.5 by 2 inches, 2 by 2 inches, 3 by 3 inches, 4 by 4 inches, 3 by 5 inches and 4 by 6 inches. In one variation, the width of the device is ¼ inch or less. In another variation, the device is substantially the size of a deck of playing cards or the size of a pack of Post-it Notes® or pack of sticky notes, or a standard business card. As used herein, the light weight portable device may weigh less than about 20-50 grams, or about half of a standard cell phone or smart phone. In another variation, the device has the utility of being colored or decorated with a general trademark or with a company's trademark or logo, or in a company's color scheme for advertisement and marketing purposes. In another variation, the device is constructed in the size and configuration that resembles a deck of cards, such as a deck of playing cards.

In another aspect of the above device, the manual switch for turning on and turning off the device is a push button installed on the front cover or on the side wall of the device. In another aspect of the device, the back cover of the portable device is further disposed for removably attaching and securing the portable device on a surface. In one variation, the attaching and securing of the portable device is a magnet for attaching onto metal surfaces, or a low, medium or high tack adhesive for re-adherable or removably attach to a variety of different surfaces such as a piece of paper, a table, chair, refrigerator, a door, computer screen, computer keyboard etc. . . . .

In another aspect of the above device, the removably attaching and securing of the portable device is selected from a magnet or an adhesive. In yet another aspect of the above device, the device comprises a flashing light emitting device (LED) indicator for indicating or alerting the liquid level and/or the presence of a recorded message.

In another implementation, the present application discloses a method for liquid level sensing and alert communication including recording and playing back an audio recording of a recorded voice message using a portable, interactive device for personal or interpersonal non-video communication using voice messaging, wherein the device comprises a substantially thin polylateral shaped housing unit comprising:

a) a front cover, a back cover and side walls connecting the front cover with the back cover;

b) a digital sound recording unit configured with a manual switch for activating and recording a message;

c) a digital sound storage unit;

d) a playback unit configured with a manual switch for activating and playing back the recorded message;

e) a microphone; and

f) a speaker; and optionally,
i) a light emitting device (LED) indicator or an audio indicator or a combination thereof, for indicating or alerting the presence of a recorded message; and/or
ii) a manual switch for turning on and turning off the device when the device is not in use;

wherein the sound recording unit, sound storage unit, playback unit, microphone and speaker are configured to allow a user to record a message and playback the message using the manual switches;

A) the recording method comprising:

i) pressing the manual switch to activate and record a message;

ii) speaking into the microphone to record the message; and

iii) de-pressing the manual switch to complete or end the recordation of the message; and

B) the play-back method comprising:

i) pressing the manual switch to activate and play back the recorded message;

and optionally, noting the LED indicator or an audio indicator, or a combination thereof, for indicating or alerting the presence of a previously recorded message.

In one variation of the method, the device may be configured to allow recordation of a message, and the manual switch may be activated or initiated by pressing and releasing the manual switch once to start recording the message, and then pressing and releasing the manual switch a second time to stop recording the message. In yet another variation, the device may be configured to allow recordation of a message, and the manual switch may be activated or initiated by pressing and keeping the switch pressed, or de-pressed to start and continue recording the message, and then releasing the manual switch to stop recording the message. In some implementations, a number of presses may be used for one or a variety of functions. For example, a selected number of depressions of the button may be used to educate the device as to an empty state of the container. One such desirable number of button depressions is six times, selected to be sufficiently more than one or two or three or like number of accidental depressions that could occur during positioning of the device, but, not so many as to be unduly cumbersome. Even so, the number of depressions for such a calibration event could be more or less than six depending upon preselected desired programming.

In one aspect of the above method, the manual switch for turning on and turning off the device is a push button installed on the front cover or on the side wall of the device. In another aspect of the method, the back cover of the portable device further comprises elements for removably attaching and securing the portable device on a surface. In yet another aspect, the elements for removably attaching and securing the portable device is selected from a magnet or an adhesive. In another aspect of the above method, the device comprises a flashing light emitting device (LED) indicator for indicating or alerting the presence of a recorded message.

In another implementation, the above device may be accompanied and/or employed along with one or more products that requires instructions, such as clarifying instructions that may accompany written instructions, to facilitate the assembly and/or the use of a particular product. In addition, a product that has been ordered by a consumer may require special instructions to assemble and/or use of the product. In addition, such devices having a pre-recorded message may be used to accompany a product, where the manufacturer may provide a particular message and/or further advertisement of one or more additional product(s) directed at the consumer.

In another implementation, the above device may be accompanied and/or employed along with one or more products, such as a medicine or drug, that requires special instructions for taking or administering a drug. For example, such device may include a pre-recorded message that allows a user, such as a patient, to press the manual play back switch to activate and replay a pre-recorded message that provides clear instructions or a reminder, to take a particular quantity of the particular drug, at a particular time, according to a physician's instructions, pharmacist's instructions or the manufacturer's instructions. When employed in this method, the device provides only a non-erasable recorded message by the manufacturer or pharmaceutical company, and may not be configured with a further manual recording switch for the user, patient or consumer. Such application may be particularly helpful for consumers who may have difficulty in reading small prints, who may be visually impaired, and/or who may have poor memory for following instructions, for example, for taking a medicine.

In another variation for using the device, the device may be accompanied or stored with a product that may be sold on-line, or at a retail store, where the product may require further comments, directions for assembly and use, or further advertisement to related products or offerings, or provide general information (such as the company's web address and phone number) and other information about the company or related products.

In another implementation, the device is an interactive device for personal or interpersonal non-video communication using voice messaging comprising a substantially thin, curvilinear housing unit that is attached to a bottle, the device comprising:

a) a front cover and side walls connecting the front cover with the outer surface of the bottle;

b) a digital sound recording unit configured with a manual switch for activating and recording a message;

c) a digital sound storage unit;

d) a playback unit configured with a manual switch for activating and playing back the recorded message;

e) a microphone; and

f) a speaker; and optionally,
i) a light emitting device (LED) indicator or an audio indicator or a combination thereof, for indicating or alerting the presence of a recorded message; and/or
ii) a manual ON/OFF switch for turning on and turning off the device when the device is not in use; wherein the sound recording unit, sound storage unit, playback unit, microphone and speaker are configured to allow a user to record a message and playback the message using the manual switches.

The curvilinear device may be attached or glued to the outside surface of a bottle using a standard adhesive, such as a glue, such as an acrylate glue. The backside housing part 508 of FIG. 6 may have one or more particular regions adapted to hold or contain an adhesive patch or sticker to allow the device to be attached to the outside surface of a container.

An interactive device for personal or interpersonal non-video communication using voice messaging comprising a substantially thin, curvilinear housing unit that is structured to be attachable to a curvilinear surface such as a bottle, the device comprising:

a) a front cover and side walls connecting the front cover with a back cover that is configured to be attachable to an outer surface of a bottle;

b) a digital sound recording unit configured with a manual switch for activating and recording a message;

c) a digital sound storage unit;

d) a playback unit configured with a manual switch for activating and playing back the recorded message;

e) a microphone; and

f) a speaker; and optionally,

i) a light emitting device (LED) indicator or an audio indicator or a combination thereof, for indicating or alerting the presence of a recorded message; and/or

ii) a manual ON/OFF switch for turning on and turning off the device when the device is not in use; wherein the sound recording unit, sound storage unit, playback unit, microphone and speaker are configured to allow a user to record a message and playback the message using the manual switches.

In one variation of each of the above implementations and variations, the device is incorporated or structured with a video monitor and video and audio recording system for recording and playing back a video message from the device.

In one variation of the device that is attached to a bottle or a can, the bottle or can may be used to hold liquids, such as carbonated or non-carbonated drinks such as soft drinks or soda, beer, wine, Scotch, bourbon, whiskey, or powders such as protein powders, sugar, flower or other food powders such as protein powders, or other non-food powders. In one variation of such uses, the accompanied device on the bottle may be used may the manufacturer to provide a message such as information or advertisement.

In another implementation, the bottle is a medicine bottle or a pill bottle for storing and dispensing of medicine or drugs. In one implementation, a drug manufacturer, a doctor or a pharmacist may record a specific and detailed message onto the device such that a user or message receiver, such as a patient, may retrieve the message at a desired time, by pressing or activating the manual play back switch. Such a device comprises an integrated chip that is programmed to retain and store the message such that when a user plays back or replays the message, the message is not erased from memory.

The developments, both as to its structure, organization and method of operation, together with further objects and advantages thereof, will best be understood with reference to the following specification taken in connection with the accompanying drawings.

Representative Specifications for a 30 Seconds Recording Device:

In one example of the device, the specification and configuration of the device is as follows:

300 Ma rechargeable lithium battery. Battery size is 32*30*4 mm. Battery capacity is 300 milliampere (ma).

Belt charging guard plate.

The memory capacity is 4 MB

The sound chip is an SOP-16 package patch chip with a model number TR1803S84-5.

The PCB board specification is PCB size: 40*32*1 mm, 94HB and model number ZXS1806-30.

The EVA foam filling material is EVA size of 75*75*8 mm and 38 degree, white EVA.

The LED light specification is as follows: LED diameter: 3 mm; LED light color: red, and LED light shape: circle.

The speaker specification is as follows: Speaker size is 27 mm and the speaker is 8R 0.5 W Iron speaker.

The microphone specification is a microphone of size 4.5 mm and with a sensitivity of −54.

The ON/OFF switch specification is as follows: Power switch is 10*5*5 mm sliding switch, with a Record/Play button size of 12*12*4.5 mm.

The magnet specification is a magnet diameter of 10 mm and a thickness of 5 mm.

The paper specification is a paper quality of 250 gsm.

For example, a user may write a simple note to self as a reminder, or to another person to relay a message or a reminder. Such message may include, for example, a greetings note, a to-do list, a reminder to self or a reminder to others of events, activities or to follow up on a task, communicate, make contact to the user, or any other short or brief message. Typically, for preparing and delivering a quick, short or brief message, a user may write on a piece of paper or a commercial note, such as a sticky note or a Post-it Note®. However, such notes are relatively limited in the amount of information that may be readily relayed; or it may require a relatively longer period to hand write an extended message, particularly where further notations, elaborations or explanations are required. Such messages are then left on a person's desk or chair, or where a Post-it Note® is used, the sticky note may be placed on a chair, desk, keyboard, computer monitor or any other open or available surface area or space that is readily visible. And when the recipient of the note reads the note, the hand written note cannot be re-used, as it is thrown away and not re-used or recycled.

Accordingly, there is a need for an alternative ways of communicating brief or short messages between users that is relatively inexpensive, expedient, efficient, and re-usable.

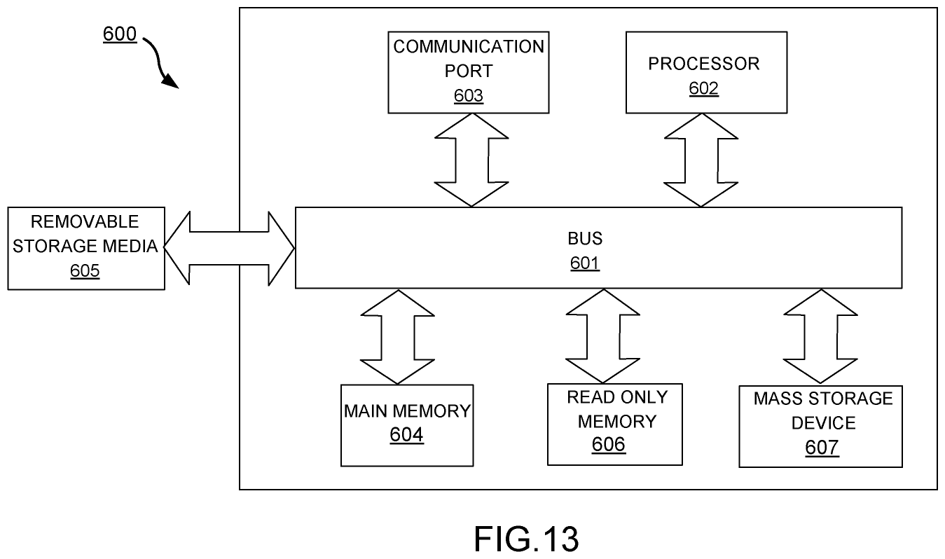

FIG. 13 provides an example of computing resources or computer system 600 or computing resources with which implementations hereof may be utilized. Some implementations of the present developments may include various steps and methods, such as those described in FIG. 4 and FIG. 10, inter alia, and a variety of these steps may be performed by hardware components or may be embodied in machine-executable instructions, which may be used to cause a general-purpose or special purpose processor programmed with instructions to perform the steps. Alternatively, the steps may be performed by a combination of one or more of hardware, software, and firmware. Thus, FIG. 13 provides computing resources or a computer system 600 that may be utilized with the implementations and developments disclosed herein. According to the present example, such a computer system 600 may include a bus 601, at least one processor 602, at least one communication port 603, a main memory 604, a removable storage media 605, a read only memory 606, and a mass storage device 607. More or fewer of these elements may be used in a particular implementation hereof.

Processor(s) 602 can be any known processor, such as, but not limited to, an Intel® Atom® Processor x5 or x7 Cherry Trail, ARM Cortex-A72 or Cortex-A17, AMD® Ryzen™, or other similar type processors. Communication port(s) 603 can be any of an RS-232 for use with a modem based dialup connection, a 10/100 Ethernet port, a Universal Serial Bus (USB) port, or a Gigabit port using copper or fiber. Communication port(s) 603 may be chosen depending on a network such as a Local Area Network (LAN), Wide Area Network (WAN), or any network to which the computer system 600 connects or may be adapted to connect.

Main memory 604 can be Random Access Memory (RAM), or any other dynamic storage device(s) commonly known in the art. Read only memory 606 can be any static storage device(s) such as Programmable Read Only Memory (PROM) chips for storing static information such as instructions for processor 602. In some instances, the implementation may include, for example, 1 GB, 2 GB, 4 GB, of DDR3 RAM, or 1 GB, 2 GB, 4 GB, or 8 GB of DDR4-3200 single-channel RAM.

Mass storage 607 may in some instances be used to store information and instructions. For example, hard disks such as Adaptec® family of SCSI drives, an optical disc, an array of disks such as RAID, or any other mass storage devices may be used. Alternatively, up to 64 GB of soldered eMMC storage may be utilized in other implementations.

Bus 601 communicatively couples processor 602 with the other memory, storage, and communication blocks. Bus 601 can be a PCI/PCI-X or SCSI based system depending on the storage devices used.

Removable storage media 605 can be any kind of external hard drive, including SD cards and microSD cards.

The components described above are meant to exemplify some types of possibilities. In no way should the aforementioned examples limit the scope of the developments, as they are solely exemplary of possible implementations.

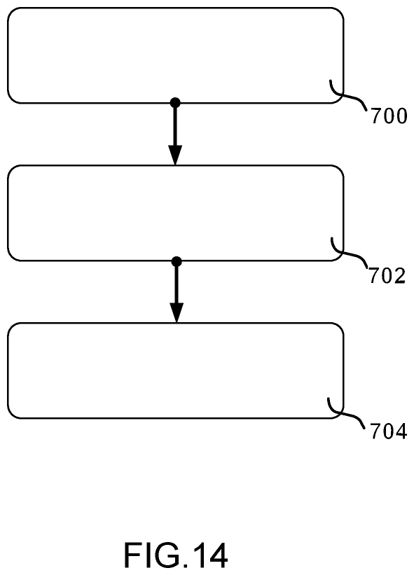

FIG. 14 provides a flow chart showing an exemplar methodology for operating the device hereof. The method may include installing the device on a container at a desired level 700, sensing whether a liquid is present or not 702, and providing a visual or audio alert to a user as to the status of the status as detected by the sensor 704. Several additional operations may be present in alternative methods of the developments, such as initializing and programming the sensor, recording a voice message, programming and choosing the length or method of delivery of an alert whether via audio or visual, or via another method such as a text message to a cellular device.

Various aspects described herein may be embodied as an apparatus, a device or a method. Accordingly, those aspects may take the form of an entirely hardware and electronic implementation. Aspects of the disclosure have been described in terms of illustrative implementations and variations thereof. Numerous other implementations, modifications and variations within the scope and spirit of the appended claims will be ascertained to persons of ordinary skill in the art from a review of this disclosure. For example, one of ordinary skill in the art will appreciate that the steps illustrated in the illustrative implementations and figures may be performed in other than the recited order, and that one or more steps illustrated may be optional in accordance with aspects of the disclosure.

1. (canceled)

2. (canceled)

3. (canceled)

4. (canceled)

5. (canceled)

6. (canceled)

7. (canceled)

8. (canceled)

9. (canceled)

10. (canceled)

11. A device comprising a sensor indicator for a contact or non-contact liquid level sensing and indication or communication using one or more of lights, sounds and/or audible voice messaging, or WiFi enabled “Push Notification” messaging through a user's smart phone, the device comprising a substantially thin shaped housing unit comprising:
a) a front cover, a back cover and one or more side walls connecting the front cover with the back cover (the housing may be relatively flat or may be curvilinear for bottle use);
b) a non-intrusive liquid sensing element;
c) an indicator or communication unit for indicating or alerting the presence of a liquid at a particular level, including one or more of:
i) a light emitting device (which may be an LED) indicator and/or
ii) an audio indicator or a combination thereof,
A) a digital sound unit configured for activating/playing and/or recording a message to be played;
B) a digital sound storage unit;
C) a playback unit that may include a speaker.

12. A device according to claim 11 further comprising one or both of:
a power supply or connection, a calibration functionality and/or a manual ON/OFF switch for turning on and turning off the device when the device is not in use; or
the sound unit which including a recording unit, and a sound storage unit, playback unit, a microphone and speaker configured to allow a user to record a message and playback the message using manual or other types of switches.

13. A portable, interactive device for liquid level sensing and communication including voice messaging comprising a substantially thin shaped housing unit comprising:
a) a front cover, a back cover and side walls connecting the front cover with the back cover;
b) a digital sound recording unit configured with a manual switch for activating and recording a message;
c) a digital sound storage unit;
d) a playback unit configured with a manual switch for activating and playing back the recorded message;
e) a microphone; and
f) a speaker; and optionally,
i) a light emitting device (LED) indicator or an audio indicator or a combination thereof, for indicating or alerting the presence of a recorded message; or
ii) a manual ON/OFF switch for turning on and turning off the device;
the sound recording unit, sound storage unit, playback unit, microphone and speaker being configured to allow a user to record a message and playback the message using the manual switches.

14. The device claim 13, the device being configured for learning and memorizing empty portion of a container; by one or more of:
by pushing the on/off button six times it will learn the empty part of the container; or
testing the unit to make sure it will react by beeping to the filled portion of the same container.

15. The device claim 13, further comprising one or more of:
the device being WiFi enabled and configured to text message or send push notification to the user;
WiFi enabled “Push Notification” messaging through a user's smart phone; or
communication to or through the Internet of things or IOT; or
a surface of a device hereof including alternative messaging types, as
display or broadcast or transmission of information or alarm or notification of electronic or electromagnetic presentations such as light emitting diode or LED presentations, or other electronic presentation forms providing visual or aural or other sensory signals, liquid crystal display, or LCD, plasma or other presentation forms or bluetooth or the like or i-beacon, or Bluetooth Low Energy or BLE or another low-power or lower frequency version of Bluetooth, such presentations perhaps providing scrolling, static, flashing, random or updateable custom messaging, such messaging alternatively being re-programmable on particular devices or being set such that alternative messaging being provided by replacing the LED or other electronic presentation or communication part of the device;
re-programmability including an ability to broadcast or near-cast a programming or programmed signal to or from one or more electronic presentation/communication devices simultaneously or serially;
Radio Frequency or RF signals or RF Identification or RFID;
presentations aurally sent via one or more sensor/indicator apparatuses to an individual user via the airspace between the user and the sensor/indicator device, or to listening device such as a headset or an earbud;
the listening device being radio frequency enabled to receive radio frequency signals from the advertising apparatus, such as being an AM or FM or like or other radio device;
any of these being used for general alarm mode, or other information communication;
or, as indicated, the alarming or other information being communicated to or through wife or local area communication to the internet or to a local receiver for processing or data collection or communication; or
communication or data collection occurring through a data communication systems or hardware one or more of locally, within a room, or within a few near rooms, or within a building, or off-site, or to other parts of a building or campus, or further.

16. The device claim 13, further comprising one or more of:
a circular housing
the polylateral shaped housing unit being a quadrilateral housing or trilateral housing unit
the quadrilateral being selected from the group comprising a rectangular, a square and a rhombus or
the housing unit being a square or rectangular shaped.

17. The device of claim 11, the size of the housing unit being about 3 inches by 3 inches, or about 3 inches by 5 inches, and a width of about ¼ inch.

18. The device of claim 13, the manual switch for turning on and turning off the device being a push button installed on the front cover or on the side wall of the device.

19. The device of claim 13, the back cover of the portable device further comprises one or more attachment elements for removably attaching and securing the portable device on a surface.

20. The device of claim 19, wherein the one or more attachment elements for removably attaching and securing the portable device being selected from a magnet or an adhesive.

21. The device of claim 11, the device comprises a flashing light emitting device or LED indicator for indicating or alerting the presence of a recorded message.

22. (canceled)

23. A device for liquid level sensing and communication, the communication including recording and playing back an audio recording of a recorded voice message using a portable, interactive device for personal or interpersonal non-video communication using voice messaging, the device comprises:
I. a substantially thin polylateral shaped housing unit comprising:
a) a front cover, a back cover and side walls connecting the front cover with the back cover; or
II. a substantially thin, curvilinear housing unit that is attached to a bottle,
a).i) a) a front cover and side walls connecting the front cover with the outer surface of the bottle;
both the devices of I. and II. comprises:
b) a digital sound recording unit configured with a manual switch for activating and recording a message;
c) a digital sound storage unit;
d) a playback unit configured with a manual switch for activating and playing back the recorded message;
e) a microphone; and
f) a speaker; and optionally,
i) a light emitting device or LED indicator or an audio indicator or a combination thereof, for indicating or alerting the presence of a recorded message; or
ii) a manual switch for turning on and turning off the device;
the sound recording unit, sound storage unit, playback unit, microphone and speaker are configured to allow a user to record a message and playback the message using the manual switches;
A) the recording method comprising:
i) pressing the manual switch to activate and record a message;
ii) speaking into the microphone to record the message; and
iii) de-pressing the manual switch to complete or end the recordation of the message; and
B) the play-back method comprising:
i) pressing the manual switch to activate and play back the recorded message;
and optionally, noting the LED indicator or an audio indicator, or a combination thereof, for indicating or alerting the presence of a previously recorded message.

24. The device of claim 23, the polylateral shaped housing unit being a quadrilateral housing or trilateral housing unit.

25. The device of claim 24, the quadrilateral being selected from the group comprising a rectangular, a square and a rhombus.

26. The device of claim 25, the housing unit being a square or rectangular shaped.

27. The device of claim 23, the size of the housing unit being about 3 inches by 3 inches, or about 3 inches by 5 inches, and a width of about ¼ inch.

28. The device of claim 23, the manual switch for turning on and turning off the device being a push button installed on the front cover or on the side wall of the device.

29. The device of claim 23, the back cover of the portable device further comprises one or more attachment elements for removably attaching and securing the portable device on a surface.

30. The device of claim 29, the one or more attachment elements for removably attaching and securing the portable device being selected from a magnet or an adhesive.

31. The device of claim 30, the device comprises a flashing light emitting device or LED indicator for indicating or alerting the presence of a recorded message.
